(19) United States
(12) Patent Application Publication
(10) Pub. No.: US 2021/0146183 A1
(43) Pub. Date: May 20, 2021

(54) NEW SURFACTANT MIXTURE, NEW COMPOSITION COMPRISING SAME, AND USE THEREOF IN FOAM LIQUIDS FOR FIGHTING FIRES

(71) Applicant: SOCIETED D'EXPLOITATION DE PRODUITS POUR LES INDUSTRIES CHIMIQUES SEPPIC, Paris (FR)

(72) Inventors: Marie-Françoise GAYRAL CHIRAC, Viviers-les-Montagnes (FR); Jérôme GUILBOT, Castres (FR); Georges DACOSTA, Saix (FR)

(21) Appl. No.: 16/623,432

(22) PCT Filed: May 22, 2018
(86) PCT No.: PCT/FR2018/051221

§ 371 Date: Dec. 17, 2019

(30) Foreign Application Priority Data
Jun. 22, 2017 (FR) 1755693

(51) Int. Cl. A62D 1/02; B01F 17/00; A62C 99/00

(52) U.S. Cl. CPC A62D 1/0085; A62D 1/0071; B01F 17/0092; A62C 99/0036; B01F 17/0042; B01F 17/0035; B01F 17/0021

(57) ABSTRACT

Disclosed is a surfactant mixture including: (i) 50%-99% of C1 which includes, per 100% of its weight: (a) 65%-90% of alkyl glutamate with C7-C17, and (b) 10%-35% of formula R1-C(═O)—OH; and (ii) 1%-50% of C2 which includes, per 100% of its weight: (c) 14-80% of C3, represented by R3-O-(G3)p-H where R3 represents C12-C16, G3 represents the residue of a reducing sugar, and 1.05≤p≤5, (d) 0%-3% of an alcohol R3-OH, (e) 20%-80% of C4, which is represented by R4-O-(G4)q-H where R4 represents C4-C7, G4 represents the residue of a reducing sugar and 1.05≤q≤5, and (f) 0%-3% of an alcohol R4-OH. Also disclosed are a fire-fighting foam liquid and a method for extinguishing a fire.

### BACKGROUND OF THE INVENTION

### Field of the Invention

The present invention relates to a novel mixture of surfactants, to compositions comprising same and to the use thereof for the preparation of firefighting foam liquids. Foams consist of a set of gaseous cells separated by thin layers of liquids and are formed by the juxtaposition of more or less fine bubbles generated by a gas dispersed in a liquid. They are generally prepared from aqueous compositions comprising at least one foaming surfactant by mixing a gas, for instance air or nitrogen or carbon dioxide. Certain surfactants are known to generate foams by mixing with gases.

### Description of the Related Art

It is well known to use compositions comprising at least one foaming surfactant to form foams intended for extinguishing fires. Mention may be made of four modes of action of fire-extinguishing foams: insulation of the flammable vapors and gases, cooling with the water contained in the foam, smothering of the fire and barrier against the radiant heat of a fire point. Foams, which are lighter than liquids, are sent over the surface of a fire or into a volume which is on fire, and act mainly by cooling and/or by smothering; in the latter case, the foams form an insulating cover, preventing the supply of oxygen (the comburant) to the fire and thus insulating it from the combustible.

These foams are particularly suitable for the fire extinction of flammable liquids, for instance solvents, and more particularly alcohols (methanol, ethanol, propanol, butanol), amines, ketones (acetone, methyl ethyl ketone), esters (methyl acetate, ethyl acetate) and hydrocarbons.

To produce the foam, it is necessary to vigorously mix water under pressure, a foam liquid and a gas (for instance air, carbon dioxide or nitrogen).

A foam liquid is a fluid which has the property of reducing the surface tension of the water with which it is mixed, allowing the formation of gas bubbles when water, the foam liquid and gas are placed in contact. Mixtures comprising foaming agents intended to produce foam for extinguishing fires are known as “firefighting foam liquids” and are generally sprayed onto the fire in the form of a foam obtained after they have been mixed under pressure with water.

The foams are characterized by their degree of expansion, their rate of expansion and their stability.

The degree of expansion (T_{F}) is the ratio between the volume of foam produced by a foaming composition to the volume of the foaming solution used (water and foam liquid). Consequently, the more the degree of expansion increases, the lighter the foam and the greater its volume, and thus the more the distances to which said foam is sprayed fall. In the technical field of fire control, the following are distinguished:
very-low-expansion foams, for which (T_{F}) is less than 4; they form a gel or a film at the surface of the liquids with the film-forming foam liquids, and thus contribute toward slowing down the evaporation;
low-expansion foams, for which (T_{F}) is greater than or equal to 4 and less than 20; they can be sprayed to great distances by means of mobile spray lances or cannons; they are stable, provide a resistant cover on the fire and are sparingly sensitive to atmospheric conditions;
medium-expansion foams, for which (T_{F}) is greater than or equal to 20 and less than 200; they can be sprayed up to about 10 meters, they prove to be more sensitive to bad weather and their resistance to reignition is less than that of low-expansion foam. They can be used in cases where large amounts of foams are required but the water supplies are limited, and they are also suitable for the retention treatment of leaks or of liquefied gases.
high-expansion foams, for which (T_{F}) is greater than or equal to 200; they are suitable for combating fires in large volumes, but are light and can thus be dispersed by the wind. They are better suited to interior use, for example for fires of hydrocarbon or polar liquid storage tanks.

As foam liquids used in fire control, there are notably protein-based foam liquids, fluoroprotein-based foam liquids, foam liquids which form floating films, known as AFFF, meaning: “Aqueous Film-Forming Foam”, and multi-purpose foam liquids known as A4P, meaning “Agent Produisant une Pellicule Protectrice Polyvalente [Multi-Purpose Protective Film-Forming Agent]” or ARAFFF, meaning: “Alcohol Resistant Aqueous Film-Forming Foam”.
Protein-based foam liquids consist of protein hydrolyzates; they make it possible to obtain foams with efficient resistance to reignition and are preferred for combating large fires in chemical and/or petroleum industrial plants;
AFFF foam liquids enable rapid extinction of fires caused by hydrocarbon-based liquids; they comprise non-fluoro surfactants and fluoro surfactants which have a very low surface tension value and consequently make it possible to produce a foam, which, by decantation, forms an aqueous film floating over the surface of the hydrocarbon, which makes it possible to extinguish the fire and to avoid potential reignition. However, they are not efficient for fires caused by polar solvents, notably alcohols, ketones and esters of low molecular weights.

ARAFF foam liquids make it possible to combat fires of polar solvents. They also comprise fluoro surfactants, non-fluoro surfactants and a water-soluble polymer; this polymer precipitates on contact with the polar solvent and forms a protective layer between said polar solvent and the foam.

The presence of non-fluoro surfactants in foam liquids of AFFF and ARAFFF type make it possible to acquire other features that are useful in fire extinction, such as the rapid formation of a sufficiently large volume of a sufficiently stable foam.

The international patent applications published under the numbers WO 91/01160 and WO 92/15371 describe the preparation of firefighting foam liquids of AFFF and ARAFFF type containing nonionic surfactants such as alkylpolyglycosides, sold under the brand names “APG 300” and “APG 325”, the alkyl chains of which comprise from 9 to 11 carbon atoms.

The international patent application published under the number WO 96/38204 discloses a foaming composition comprising at least one fluoro surfactant and at least one alkylpolyglycoside hemisulfosuccinate surfactant on linear or branched alkyl chains including from 6 to 18 carbon atoms. The international patent application published under the number WO 92/15371 does not teach of or encourage combining nonionic surfactants such as alkylpolyglycosides with anionic surfactants such as N-acyl derivatives of glutamic acid, since WO 92/15371 discloses that the combination with “sodium decyl sulfate” allows an “increase in the foam expansion” (WO 92/15371, page 6, lines 25 to 27).

The American patent published under the number U.S. Pat. No. 5,434,192 discloses the use of aqueous compositions comprising a polymer, a solvent, a fluoro surfactant and one or more nonionic surfactants of alkylpolyglycoside type, said composition being intended to generate a foam used for suppressing vapors of hydrocarbons and of organic solvents following a spillage.

To obtain high-stability foams, a person skilled in the art must combine foaming surfactants with one or more additives having the effect of increasing the stiffness of the gas cells forming the foam.

The French patent application published under the number 2 439 230 discloses the use of fatty amines as foaming auxiliary, aqueous solutions of surfactants such as alkylbetaines, alkylamidobetaines, alkyl sulfates or alkyl ether sulfates.

The international patent application published under the number WO 03/035794 A1 teaches that an alkyl phosphate monoester improves the stability of a used in an oil well drilling process.

However, the foam-stabilizing additives are often poorly biodegradable and are occasionally toxic, which makes them noncompliant with the new environmental requirements and regulatory provisions. They thus proved to be unusable in foams intended for combating open-air fires, notably in a woodland environment.

New technical solutions have recently been developed for preparing surfactants which generate stable foams without the addition of foam-stabilizing additives. Mention may thus be made of the international patent application published under the publication number WO 2012/085391 A1, which discloses a process for drilling cavities in underground formations, using an aqueous fluid which is in the form of a foam obtained by mixing a gas or a gas mixture and an aqueous solution comprising an N-acyl derivative of glutamic acid, or a salt thereof, and/or of aspartic acid, or a salt thereof, for which the acyl radical includes from 8 to 18 carbon atoms. The foams generated by the aqueous solutions comprising such N-acyl derivatives of glutamic acid, or a salt thereof, and/or of aspartic acid, or a salt thereof, have the advantage both of being formed with a short expansion time and of showing mechanical properties that make them suitable for use in a step of rubble removal during an underground cavity drilling operation.

However, it has been observed by the Applicant that the properties of the foams formed from aqueous solutions comprising N-acyl derivatives of glutamic acid or a salt thereof, and/or of aspartic acid or a salt thereof, required for fire extinction uses, notably the expansion time and the foam stability, presented variations making them of random efficiency.

### SUMMARY OF THE INVENTION

There is thus a need for surfactant systems that are capable of generating a foam with a sufficiently rapid expansion time, which remains sufficiently stable and which has a degree of expansion of less than or equal to 20, so that they can be used in firefighting.

This is why a first subject of the invention is a surfactant mixture (M₁), characterized in that it comprises, per 100% of its mass:

(i)—from 50% to 99% by mass, more particularly from 55% to 99% by mass and even more particularly from 57% to 99% by mass of a composition (C₁) comprising, per 100% of its mass:

(α)—from 65% to 90% by mass, more particularly from 65% to 85% by mass and most particularly from 65% to 80% by mass of at least one compound of formula (I):

R₁—C(═O)—NH—CH(COOH)—(CH₂)₂—COOH (I)

in partially or totally salified acid form in which the group R₁—C(═O)— represents a linear or branched, saturated or unsaturated acyl radical including from 8 to 18 carbon atoms, and

(β)—from 10% to 35% by mass, more particularly from 15% to 35% by mass and most particularly from 20% to 35% by mass of at least one compound of formula (II):

R₁—C(═O)—OH (II)

in partially or totally salified form in which the group R₁ is as defined for formula (I),
(ii)—from 1% to 50% by mass, more particularly from 1% to 45% by mass and even more particularly from 1% to 43% by mass of a composition (C₂) comprising, per 100% of its mass:

(γ)—from 14% to 80% by mass of a composition (C₃) or of a mixture of compositions (C₃), said composition (C₃) being represented by formula (III):

R₃—O-(G₃)ₚ-H (III)

in which R₃ represents a linear or branched, saturated or unsaturated aliphatic radical including from 12 to 16 carbon atoms, G₃ represents a reducing sugar residue and p represents a decimal number greater than or equal to 1.05 and less than or equal to 5, said composition (C₃) consisting of a mixture of compounds represented by formulae (III₁), (III₂), (III₃), (III₄) and (III₅):

R₃—O-(G₃)₁-H (III₁),

R₃—O-(G₃)₂-H (III₂),

R₃—O-(G₃)₃-H (III₃),

R₃—O-(G₃)₄-H (III₄),

R₃—O-(G₃)₅-H (III₅),

in the respective molar proportions a₂, a₃, a₄ and a₅, such that:
the sum a₁+a₂+a₃+a₄+a₅ is equal to 1, and
the sum a₁+2a₂+3a₃+4a₄+5a₅ is equal to p;

(δ)—from 0% to 3% by mass of at least one alcohol of formula (IV):

R₃—OH (IV)

in which R₃ is as defined for the preceding formula (III),

(∈)—from 20% to 80% of a composition (C₄) or of a mixture of compositions (C₄), said composition (C₄) being represented by formula (V):

R₄—O-(G₄)_{q}-H (V)

in which R₄ represents a linear aliphatic radical, chosen from butyl radicals (n-C₄H₉—), the pentyl radical (n-C₅H₁₁—), the hexyl radical (n-C₆H₁₃—), the heptyl radical (n-C₇H₁₅—), G₄ represents a reducing sugar residue and q represents a decimal number greater than or equal to 1.05 and less than or equal to 5, said composition (C₄) consisting of a mixture of compounds represented by formulae (V₄), (V₂), (V₃), (V₄) and (V₅):

R₄—O-(G₄)₁-H (V₁),

R₄—O-(G₄)₂-H (V₂),

R₄—O-(G₄)₃-H (V₃),

R₄—O-(G₄)₄-H (V₄),

R₄—O-(G₄)₅-H (V₅),

in the respective molar proportions a′₁, a′₂, a′₃, a′₄ and a′₅, such that:
the sum a′₁+a′₂+a′₃+a′₄+a′₅ is equal to 1, and
the sum a′₁+2a′₂+3a′₃+4a′₄+5a′₅ is equal to q; and

(η)—from 0% to 3% by mass of at least one alcohol of formula (VI):

R₄—OH (VI)

in which R₄ is as defined for the preceding formula (V).

The term “compounds of formula (I) or (II) in partially or totally salified acid form” means that in the context of the present invention, one, several or all of the carboxyl functions present in one or other of said compounds of formula (I) or (II) is either in acid form (—COOH) or in salified form (—COO⁻M⁺). In the latter case, M⁺ represents a monovalent cation chosen from:
the ammonium cation,
monovalent cations of alkali metals, for example the sodium (Na⁺), potassium (K⁺) or lithium (Li⁺) cation,
   (hydroxyalkyl)ammonium, bis(hydroxyalkyl)ammonium or tris(hydroxyalkyl)ammonium cations in which the hydroxyalkyl radicals include from 1 to 4 carbon atoms, for example 2-hydroxyethanammonium, 2-hydroxypropanammonium, bis(2-hydroxyethyl)ammonium and tris(2-hydroxyethyl)ammonium cations,
   (alkyloxyalkyl)ammonium, bis(alkyloxyalkyl)ammonium or tris(alkyloxyalkyl)ammonium cations in which the alkyloxyalkyl radical(s) include from 2 to 6 carbon atoms, for example the 2-ethoxyethanammonium cation,
(hydroxyalkylaminoalkyl)ammonium, bis(hydroxyalkylaminoalkyl)ammonium or tris(hydroxyalkylaminoalkyl)ammonium cations in which the hydroxyalkylaminoalkyl radical(s) include from 2 to 6 carbon atoms, for example the 2-hydroxyethylaminomethanammonium cation and the 2-hydroxyethylaminoethanammonium cation.

The term “reducing sugar residue” denotes in the definition residues (G₃) and (G₄) of formulae (III) and (V) as defined previously, residues of saccharide derivatives without a glycoside bond established between an anomeric carbon and the oxygen of an acetal group, as defined in the reference publication: “Biochemistry, Daniel Voet/Judith G. Voet, page 250, John Wiley & Sons, 1990.”

The oligomeric structures (G₃)ₚ and (G₄)_{q} may be in any isomeric form, whether it is optical isomerism, geometrical isomerism or regioisomerism; it may also represent a mixture of isomers.

In formula (III) as defined above, the group R₃ is linked to G₃ via the anomeric carbon of the saccharide residue, so as to form an acetal function. Similarly, in formula (V) as defined above, the group R₄ is linked to G₄ via the anomeric carbon of the saccharide residue, so as to form an acetal function.

According to a particular aspect of the mixture (M₁) as defined previously, in formula (III), G₃ and G₄, which may be identical or different, represent, independently of each other, a reducing sugar residue, glucose, dextrose, sucrose, fructose, idose, gulose, galactose, maltose, isomaltose, maltotriose, lactose, cellobiose, mannose, ribose, xylose, arabinose, lyxose, allose, altrose, dextran and tallose.

The term “linear or branched, saturated or unsaturated aliphatic radical including from 12 to 16 carbon atoms” notably denotes for R₃ in formulae (III) and (IV):
a linear alkyl radical chosen from dodecyl (n-C₁₂H₂₅—), tetradecyl (n-C₁₄H₂₉—) and hexadecyl (n-C₁₆H₃₂—) radicals,
a branched alkyl radical derived from the isoalkanols of formula (1):

(CH₃)(CH₃)CH—(CH₂)ᵣ—CH₂—OH (1)

in which r represents an integer between 8 and 16, for example the isododecyl, isotridecyl, isotetradecyl, isopentadecyl or isohexadecyl radical;
a branched alkyl radical derived from a Guerbet alcohol of formula (2):

CH(CₛH₂ₛ₊₁)(CₜH₂ₜ₊₁)—CH₂—OH (2)

in which t is an integer between 2 and 12, s is an integer between 2 and 14 and the sum s+t is greater than or equal to 10 and less than or equal to 14, for example the 2-ethyldecyl, 2-butyloctyl, 2-ethyldodecyl, 2-butyldecyl, 2-hexyloctyl, 2-hexyldecyl or 2-butyldodecyl radical.

According to a particular aspect, said surfactant mixture (M₁) is characterized in that, in said composition (C₂), the mass proportion of alcohol of formula (VI) is equal to zero.

According to another particular aspect of the present invention, the compounds of formula (I) and of formula (II) are partially or totally salified in sodium salt or potassium salt form.

According to another particular aspect, said mixture (M₁) as defined previously comprises, per 100% of its mass, from 55% to 99% by mass of said composition (C₁) and from 1% by mass to 45% by mass of said composition (C₂), and more particularly from 57% to 99% by mass of said composition (C₁) and from 1% by mass to 43% by mass of said composition (C₂).

According to another particular aspect, composition (C₁) as defined previously comprises, per 100% of its mass, from 65% to 90% by mass of one or more compounds of formula (I) and from 10% to 35% by mass of one or more compounds of formula (II); and more particularly from 65% to 85% by mass of one or more compounds of formula (I) and from 15% to 35% by mass of one or more compounds of formula (II).

In formulae (I) and (II) as defined previously, the radical R₁—(C═O)— more particularly represents an acyl radical chosen from octanoyl, decanoyl, ω-undecylenoyl, dodecanoyl, tetradecanoyl, hexadecanoyl, octadecanoyl, 9-octadecenoyl, 9,12-octadecadienoyl and 9,12,15-octadecatrienoyl radicals.

The compounds of formula (I) as described previously are generally obtained by N-acylation of the corresponding amino acids or of salts thereof. It is described, for example, in the international patent application published under the number WO 98/09611. It is performed equivalently on an amino acid or on an amino acid mixture. The acylating agent generally consists of an activated derivative of the carboxylic acid of formula:

R₁—C(═O)—OH,

in which R₁ is as defined previously, such as a symmetrical anhydride of this acid, the methyl ester of this acid, or an acid halide such as the acid chloride or the acid bromide. It may also consist of a mixture of activated derivatives of carboxylic acids obtained from natural oils or fats of animal or plant origin such as coconut kernel oil, coconut oil, palm kernel oil, palm oil, soybean oil, rapeseed oil, corn oil, beef tallow, spermaceti oil or herring oil.

According to another particular aspect, a subject of the invention is said surfactant mixture (M₁) as defined previously, characterized in that said composition (C₁) is obtained via a process comprising at least:
one step A) of acylation of a compound of formula (VII):

NH₂—CH(COOH)—(CH₂)₂—COOH (VII),

in partially or totally salified acid form, with a mixture of acid chlorides comprising, per 100 mol %, from 40 mol % to 60 mol % of dodecanoyl chloride, from 10 mol % to 20 mol % of tetradecanoyl chloride, from 5 mol % to 15 mol % of decanoyl chloride and from 5 mol % to mol % of octanoyl chloride, and optionally up to 100 mol %, of hexadecanoyl chloride and/or of octadecanoyl chloride and/or of 9-octadecenoyl chloride and/or of octadeca-9,12-dienoyl chloride.

According to a more particular aspect, the mixture of acid chlorides used comprises, per 100 mol %, 11 mol % of octanoyl chloride, 9.5 mol % of decanoyl chloride, 51 mol % of dodecanoyl chloride, 15.5 mol % of tetradecanoyl chloride, 6.5 mol % of hexadecanoyl chloride, 2 mol % of octadecanoyl chloride, 3 mol % of 9-octadecenoyl chloride and 1.5 mol % of octadeca-9,12-dienoyl chloride.

According to another particular aspect, a subject of the invention is said surfactant mixture (M₁) as defined previously, characterized in that the compound(s) of formula (I) are chosen from monosodium N-cocoyl glutamate, monopotassium N-cocoyl glutamate, disodium N-cocoyl glutamate and dipotassium N-cocoyl glutamate.

According to another particular aspect, a subject of the invention is said surfactant mixture (M₁) as defined previously, characterized in that said composition (C₂) comprises, per 100% of its mass:
(γ)—a mass proportion of said composition (C₃) of greater than or equal to 14% and less than 70%, and
(δ)—a mass proportion of said alcohol of formula (IV) of greater than or equal to 0% and less than or equal to 3%,
(∈)—a mass proportion of said composition (C₄) of greater than or equal to 30% and less than or equal to 80%, and
(η)—a mass proportion of said alcohol of formula (VI) of greater than or equal to 0% and less than or equal to 3%.

According to an even more particular aspect, a subject of the invention is said surfactant mixture (M₁) as defined previously, characterized in that said composition (C₂) as defined previously comprises, per 100% of its mass, a mass proportion of said composition (C₃) of greater than or equal to 14% and less than or equal to 65%, a mass proportion of said alcohol of formula (IV) of greater than or equal to 0% and less than or equal to 3%, a mass proportion of said composition (C₄) of greater than or equal to 35% to and less than or equal to 80% and a mass proportion of said alcohol of formula (VI) of greater than or equal to 0% and less than or equal to 3%.

According to another particular aspect, a subject of the invention is said surfactant mixture (M₁) as defined previously, characterized in that, in said formula (III), G₃ represents a reducing sugar residue chosen from glucose, xylose and arabinose residues.

According to another particular aspect, a subject of the invention is said surfactant mixture (M₁) as defined previously, characterized in that, in said formula (III), p represents a decimal number greater than or equal to 1.05 and less than or equal to 2.5, more particularly greater than or equal to 1.05 and less than or equal to 2.0 and even more particularly greater than or equal to 1.25 and less than or equal to 2.0.

According to another particular aspect, a subject of the invention is said surfactant mixture (M₁) as defined previously, characterized in that, in formulae (III) and (IV), the radical R₃ represents a linear alkyl radical chosen from dodecyl (n-C₁₂H₂₅—), tetradecyl (n-C₁₄H₂₉—) and n-hexyldecyl (n-C₁₆H₃₂—) radicals.

According to another particular aspect, a subject of the invention is said surfactant mixture (M₁) as defined previously, characterized in that, in formula (V), G₄ represents a reducing sugar residue chosen from glucose, xylose and arabinose residues.

According to another particular aspect, a subject of the invention is said surfactant mixture (M₁) as defined previously, characterized in that, in said formula (V), q represents a decimal number greater than or equal to 1.05 and less than or equal to 2.5, more particularly greater than or equal to 1.05 and less than or equal to 2.0 and even more particularly greater than or equal to 1.25 and less than or equal to 2.0.

According to a particular aspect, a subject of the invention is said surfactant mixture (M₁) as defined previously, characterized in that, in formulae (V) and (VI), R₄ represents a linear alkyl radical chosen from hexyl (n-C₆H₁₃—) and heptyl (n-C₇H₁₅—) radicals.

According to an even more particular aspect, in formulae (V) and (VI), R₄ represents the heptyl radical (n-C₇H₁₅—).

According to another even more particular aspect, in formulae (V) and (VI), R₄ represents the n-hexyl radical (n-C₆H₁₃—).

According to another particular aspect, a subject of the invention is said surfactant mixture (M₁) as defined previously, characterized in that said composition (C₂) comprises a mixture of compositions (C₃) and of compositions (C₄), said mixture comprising, per 100% of its mass:
(γ₁)—from 13.6% to 44.4% by mass, more particularly from 17% to 44.4% by mass, of a composition (C₃) represented by formula (III) in which R₃ represents the dodecyl radical (n-C₁₂H₂₅—),
(γ₂)—from 5% to 16.25% by mass, more particularly from 6.25% to 16.25% by mass, of a composition (C₃) represented by formula (III) in which R₃ represents the tetradecyl radical (n-C₁₄H₂₉—), and
(γ₃)—from 1.4% to 4.55% by mass, more particularly from 1.75% to 4.55% by mass, of a composition (C₃) represented by formula (III) in which R₃ represents the hexadecyl radical (n-C₁₆H₃₂—), and
(∈₁)—from 35% to 80% by mass, more particularly from 35% to 75% by mass, of a composition (C₄) represented by formula (V) in which R₄ represents the heptyl radical (n-C₇H₁₅—).

According to another particular aspect, a subject of the invention is said surfactant mixture (M₁) as defined previously, characterized in that said composition (C₂) comprises a mixture of compositions (C₃) and of compositions (C₄), said mixture comprising, per 100% of its mass:
from 13.6% to 44.4% by mass, more particularly from 17% to 44.4% by mass, of a composition (C₃) represented by formula (III) in which R₃ represents the dodecyl radical (n-C₁₂H₂₅—),
from 5% to 16.25% by mass, more particularly from 6.25% to 16.25% by mass, of a composition (C₃) represented by formula (III) in which R₃ represents the tetradecyl radical (n-C₁₄H₂₉—), and
from 1.4% to 4.55% by mass, more particularly from 1.75% to 4.55% by mass, of a composition (C₃) represented by formula (III) in which R₃ represents the hexadecyl radical (n-C₁₆H₃₂—), and
from 35% to 80% by mass, more particularly from 35% to 75% by mass, of a composition (C₄) represented by formula (V) in which R₄ represents the radical the 2-ethylhexyl radical.

According to another particular aspect, a subject of the invention is said surfactant mixture (M₁) as defined previously, characterized in that the composition (C₂) comprises a mixture of compositions (C₃) comprising, per 100% of its mass:
from 13.6% to 44.4% by mass, more particularly from 17% to 44.4% by mass, of a composition (C₃) represented by formula (III) in which R₃ represents the dodecyl radical (n-C₁₂H₂₅—),
from 5% to 16.25% by mass, more particularly from 6.25% to 16.25% by mass, of a composition (C₃) represented by formula (III) in which R₃ represents the tetradecyl radical (n-C₁₄H₂₉—), and
from 1.4% to 4.55% by mass, more particularly from 1.75% to 4.55% by mass, of a composition (C₃) represented by formula (III) in which R₃ represents the hexadecyl radical (n-C₁₆H₃₂—), and
from 35% to 80% by mass, more particularly from 35% to 75% by mass, of a composition (C₄) represented by the formula (V) in which R₄ represents the n-hexadecyl radical (n-C₁₆H₃₂—).

According to a more particular aspect, a subject of the invention is said surfactant mixture (M₁) as defined previously, characterized in that, in formula (III), G₃ represents a reducing sugar residue chosen from glucose, xylose and arabinose residues, p represents a decimal number greater than or equal to 1.05 and less than or equal to 2.5, more particularly greater than or equal to 1.05 and less than or equal to 2.0 and even more particularly greater than or equal to 1.25 and less than or equal to 2.0, and R₃ represents a linear alkyl radical chosen from dodecyl (n-C₁₂H₂₅—), tetradecyl (n-C₁₄H₂₉—) and hexadecyl (n-C₁₆H₃₂—) radicals.

According to an even more particular aspect, a subject of the invention is said surfactant mixture (M₁) as defined previously, characterized in that, in formula (III), G₃ represents a glucose residue, p represents a decimal number greater than or equal to 1.05 and less than or equal to 2.5, and R₃ represents a linear alkyl radical chosen from dodecyl (n-C₁₂H₂₅—), tetradecyl (n-C₁₄H₂₉—) and hexadecyl (n-C₁₆H₃₂—) radicals.

According to another more particular aspect, a subject of the invention is said surfactant mixture (M₁) as defined previously, characterized in that, in formula (III), G₃ represents a xylose residue, p represents a decimal number greater than or equal to 1.05 and less than or equal to 2.5, and R₃ represents a linear alkyl radical chosen from the dodecyl (n-C₁₂H₂₅—) radical, the tetradecyl (n-C₁₄H₂₉—) radical and the hexadecyl (n-C₁₆H₃₂—) radical.

According to another more particular aspect, a subject of the invention is said surfactant mixture (M₁) as defined previously, characterized in that, in formula (V), G₄ represents a reducing sugar residue chosen from glucose, xylose and arabinose residues, q represents a decimal number greater than or equal to 1.05 and less than or equal to 2.5, more particularly greater than or equal to 1.05 and less than or equal to 2.0 and even more particularly greater than or equal to 1.25 and less than or equal to 2.0, and R₄ represents an aliphatic alkyl radical chosen from hexyl (n-C₆H₁₃—), and heptyl (n-C₇H₁₅—) radicals.

According to an even more particular aspect, a subject of the invention is said surfactant mixture (M₁) as defined previously, characterized in that, in formula (V), G₄ represents a glucose residue, q represents a decimal number greater than or equal to 1.05 and less than or equal to 2.5, and R₄ represents an aliphatic alkyl radical chosen from hexyl (n-C₆H₁₃—), and heptyl (n-C₇H₁₅—) radicals.

According to an even more particular aspect, a subject of the invention is said surfactant mixture (M₁) as defined previously, characterized in that, in formula (V), G₄ represents a glucose residue, q represents a decimal number greater than or equal to 1.05 and less than or equal to 2.5, and R₄ represents the heptyl (n-C₇H₁₅—) radical.

According to an even more particular aspect, a subject of the invention is said surfactant mixture (M₁) as defined previously, characterized in that, in formula (V), G₄ represents a xylose residue, q represents a decimal number greater than or equal to 1.05 and less than or equal to 2.5, and R₄ represents an aliphatic alkyl radical chosen from hexyl (n-C₆H₁₃—), and heptyl (n-C₇H₁₅—) radicals.

According to a most particular aspect, a subject of the invention is said surfactant mixture (M₁) as defined previously, characterized in that, in formula (V), G₄ represents a xylose residue, q represents a decimal number greater than or equal to 1.05 and less than or equal to 2.5, and R₄ represents the heptyl (n-C₇H₁₅—) radical.

According to an even more particular aspect, a subject of the invention is said surfactant mixture (M₁) as defined previously, characterized in that composition (C₃) is obtained by performing a process comprising at least one step A′) of glycosylation of:
1 to 5 molar equivalents, more particularly from 2 to 4 molar equivalents, even more particularly from 3 to 4 molar equivalents, of a mixture of alcohols comprising, per 100 mol %:
from 40 mol % to 90 mol % of 1-dodecanol, more particularly from 65 mol % to 90% and even more particularly from 75 mol % to 90 mol %,
from 9 mol % to 40 mol % of 1-tetradecanol, more particularly from 9 mol % to 20 mol % and even more particularly from 9 mol % to 20 mol %, and
from 1 mol % to 20 mol % of 1-hexadecanol, more particularly from 1 mol % to 15 mol % and even more particularly from 1 mol % to 5 mol %,
with 1 molar equivalent of a reducing sugar of formula (VII):

HO-(G₃)-H (VII)

in which G₃ represents a reducing sugar residue chosen from glucose, xylose and arabinose residues.

According to another particular aspect, a subject of the invention is said surfactant mixture (M₁) as defined previously, characterized in that composition (C₄) is obtained by performing a process comprising at least one step A₁′ of glycosylation of:
1 to 4 molar equivalents, more particularly from 1 to 3 molar equivalents, even more particularly from 2 to 3 molar equivalents of at least one alcohol of formula (VI) with 1 molar equivalent of a reducing sugar of formula (VIII):

HO-(G₄)-H (VIII)

in which G₄ represents a reducing sugar residue chosen from glucose, xylose and arabinose residues.

According to another particular aspect, a subject of the invention is said surfactant mixture (M₁) as defined previously, characterized in that composition (C₃) is obtained by performing a process comprising at least one step A′ of glycosylation generally performed with mechanical stirring, by placing 1 molar equivalent of a reducing sugar (G₃) in contact with from 1 to 5 molar equivalents of the mixture of 1-dodecanol, 1-tetradecanol and 1-hexadecanol as described previously, in the presence of an acidic catalytic system, under predetermined temperature and partial vacuum conditions.

Similarly, step A₁′ of the process for preparing composition (C₄), as defined previously, is generally performed with mechanical stirring, by placing 1 molar equivalent of a reducing sugar (G₄) in contact with from 1 to 4 molar equivalents of at least one alcohol of formula (V), in the presence of an acidic catalytic system, under predetermined temperature and partial vacuum conditions.

Such temperature and partial vacuum conditions are, for example, temperature values of between 70° C. and 130° C. and a partial vacuum of between 300 mbar (3*10⁴ Pa) and 20 mbar (2*10³ Pa). The implementation of step A′ and of step A₁′ of glycosylation makes it possible to form, respectively, composition (C₃), i.e. a mixture of compounds represented by the formulae (III₁), (III₂), (III₃), (III₄) and (III₅) as defined previously, and optionally of an excess of the alcohol of formula (IV) or of the mixture of alcohols (IV), and composition (C₄) i.e. a mixture of compounds represented by the formulae (V₄), (V₂), (V₃), (V₄) and (V₅) as defined previously, and optionally of an excess of the alcohol of formula (VI).

If necessary or if desired, step A′ or step A₁′ of the process for preparing the respective compositions (C₃) and (C₄) as defined previously may be followed, respectively, by a step B′ or a step B₁′ of removal of the alcohols, respectively, of formula (IV), or of the mixture of alcohols of formula (IV), and of formula (VI), which have not reacted during step A′) or step A₁′.

Such a preparation process may be completed, if necessary or if desired, by neutralization, filtration and decolorization operations.

The term “acidic catalytic system” denotes, in step A′ and in step A₁′ of the process defined above, strong acids such as sulfuric acid, hydrochloric acid, phosphoric acid, nitric acid, methanesulfonic acid, para-toluenesulfonic acid, trifluoromethanesulfonic acid, hypophosphorous acid, hyponitrous acid, polyphosphoric acid, or ion-exchange resins.

During step B′) or step B′1) of the process as described above, the alcohols, respectively, of formula (IV), or the mixture of alcohols of formula (IV) or the alcohol of formula (V) are removed according to methods known to those skilled in the art, for instance by distillation, such as thin-film distillation, molecular distillation or solvent extraction.

According to a particular aspect, a subject of the invention is said surfactant mixture (M₁) as defined previously is characterized in that the mass ratio Δ=Mass of compound(s) of formula (I)/[Mass of composition (C₃)]+Mass of composition (C₄)], is greater than or equal to 20/80 and less than or equal to 65/35, more particularly greater than or equal to 25/75 and less than or equal to 65/35.

According to a more particular aspect, a subject of the invention is said surfactant mixture (M₁) as defined previously, characterized in that the mass ratio Δ¹=mass of composition (C₃)/mass or composition (C₄) is greater than or equal to 20/80 and less than or equal to 70/30, more particularly greater than or equal to 20/80 and less than or equal to 65/35, and even more particularly greater than or equal to 25/75 and less than or equal to 65/35.

A subject of the invention is also a composition (C_{A}) characterized in that it comprises, per 100% by mass:

a)—from 5% to 85% by mass, more particularly from 20% to 60% by mass and even more particularly from 30% to 50% by mass of said (M₁) as defined previously, and
b)—from 15% to 95% by mass, more particularly from 40% to 80% by mass and even more particularly from 50% to 70% by mass of water.

A subject of the invention is also a composition (C_{E}) characterized in that it comprises, per 100% by mass:

a)—from 0.1% to 25% by mass, more particularly from 0.15% to 25% by mass and even more particularly from 0.2% to 25% by mass of said mixture (M₁) as defined previously;
b)—from 55% to 99.75% by mass, more particularly from 58.5% to 99.7% by mass and even more particularly from 61% to 99.65% by mass of water;
c)—from 0.05% to 10% by mass, more particularly from 0.05% to 7.5% by mass and even more particularly from 0.05% to 6% by mass of at least one fluoro surfactant (FSA) chosen from anionic fluoro surfactants, cationic surfactants, nonionic surfactants and amphoteric surfactants;
d)—from 0.1% to 10% by mass, more particularly from 0.1% to 9% by mass and even more particularly from 0.1% to 8% by mass of at least one gelling agent and/or thickener (GA) chosen from polysaccharides consisting of monosaccharide derivatives, polysaccharides consisting solely of monosaccharides, cellulose and cellulose derivatives, starches and linear or branched or crosslinked polyelectrolytes.

The term “fluoro surfactants” denotes, in the definition of composition (C_{E}) as defined above, organofluorine amphiphilic compounds including several fluorine atoms, which may be of polyfluoro or perfluoro nature.

The term “perfluoro surfactant” denotes a compound containing a hydrophilic radical and a terminal aliphatic perfluorocarbon radical of at least three carbon atoms and notably a perfluoro radical of formula (3):

CF₃—(CF₂)ₘ— (3),

in which m represents an integer between 2 and 11,

The branched perfluorocarbon radical of formula (3) is generally chosen from those represented by formulae (3.1), (3.2), (3.3), (3.4), (3.5) and (3.6) below:

(CF₃)₂CF(CF₂)ₘ— (3.1),
in which m′ represents an integer between 2 and 11;

CF₃—CF₂—C(CF₃)═C(CF₂—CF₃)—CF₂— (3.2),

[(C₂F₅)₂]C(CF₃)—C(CF₃)═C(CF₃)— (3.3),

CF₃—CF₂—C(CF₃)═C(CF₃)—CF₂—CF₂— (3.4),

(C₂F_{S})₂C(CF₃)—CH₂— (3.5),

(C₂F₅)₂C(CF₃)—CH═C(CF₃)— (3.6).

According to another particular aspect, a subject of the invention is a composition (C_{E}) characterized in that it comprises one or more anionic fluoro surfactants chosen from the compounds of formulae (4), (4.1), (4.2) and (4.3) below:

R_{f}SO₃⁻X⁺ (4),

R_{f}(CH₂)ₛ—COO⁻X⁺ (4.1),

R_{f}—O—C₆H₄—SO₃⁻X⁺ (4.2),

R_{f}—O—C₆H₄—CH₂—PO₄⁻X⁺ (4.3),

in which:
R_{f} represents a radical of formulae (4′) or (4″) below:

CᵣF₂ᵣ₋₁ (4′)

CᵣF₂ᵣ₊₁ (4″),

in which formula r is an integer of greater than or equal to 4 and less than or equal to 12;
X⁺ represents a proton or a monovalent cation chosen from:
   the ammonium cation,
   monovalent cations of alkali metals, for example the sodium (Na⁺), potassium (K⁺) or lithium (Li⁺) cation,
   (hydroxyalkyl)ammonium, bis(hydroxyalkyl)ammonium or tris(hydroxyalkyl)ammonium cations in which the hydroxyalkyl radicals include from 1 to 4 carbon atoms, for example 2-hydroxyethanammonium, 2-hydroxypropanammonium, bis(2-hydroxyethyl)ammonium and tris(2-hydroxyethyl)ammonium cations,
   (alkyloxyalkyl)ammonium, bis(alkyloxyalkyl)ammonium or tris(alkyloxyalkyl)ammonium cations in which the alkyloxyalkyl radical(s) include from 2 to 6 carbon atoms, for example the 2-ethoxyethanammonium cation,
   (hydroxyalkylaminoalkyl)ammonium, bis(hydroxyalkylaminoalkyl)ammonium or tris(hydroxyalkylaminoalkyl)ammonium cations in which the hydroxyalkylaminoalkyl radical(s) include from 2 to 6 carbon atoms, for example the 2-hydroxyethylaminomethanammonium cation and the 2-hydroxyethylaminoethanammonium cation, and
s represents an integer greater than or equal to 0 and less than or equal to 6.

According to another particular aspect, a subject of the invention is a composition (C_{E}) characterized in that it comprises one or more cationic fluoro surfactants chosen from those of formulae (4.4), (4.5) and (4.6) below:

R_{f}—SO₂—N(R)—(CH₂)ₛ—N⁺(R)₃Y⁻ (4.4),

R_{f}—O—C₆H₄—CH₂—N⁺(R)₃Y⁻ (4.5),

R_{f}—C₆H₄—SO₂—N(R)—(CH₂)ₛ—N⁺(R)₃Y⁻ (4.6),

in which:
R_{f} represents a radical represented by formula (4′) or by formula (4″) as described above,
s represents an integer greater than or equal to 0 and less than or equal to 6 as described above,
Y⁻ represents a monovalent anion chosen from chloride, bromide, iodide and methosulfate anions,
R represents a hydrogen atom or a linear or branched alkyl radical including from 1 to 4 carbon atoms.

According to another particular aspect, a subject of the invention is a composition (C_{E}) characterized in that it comprises one or more nonionic fluoro surfactants of formulae (4.7), (4.8), (4.9), (4.10) and (4.11) below:

R_{f}—O—(CH₂CH₂O)ₜ—R (4.7),

R_{f}—O—(CH₂CH₂O)ₜ—R_{f} (4.8),

R_{f}—O—C₆H₄—CH₂—O—(CH₂CH₂O)ₜ—R (4.9),

R_{f}—O—C₆H₄—CH₂—O—(CH₂CH₂O)ₜ—R_{f} (4.10),

R_{f}—O—C₆H₄—SO₂—O—(CH₂CH₂O)ₜ—SO₂—C₆H₄—O—R_{f} (4.11)

in which:
R_{f} represents a radical represented by formula (4′) or by formula (4″) as described above,
R represents a hydrogen atom or a linear or branched alkyl radical including from 1 to 4 carbon atoms,
t represents an integer greater than or equal to 1 and less than or equal to 40.

According to another particular aspect, a subject of the invention is a composition (C_{E}) characterized in that it comprises one or more amphoteric fluoro surfactants chosen from
those of formulae (4.12), (4.13), (4.14), (4.15), (4.16), (4.17) and (4.18) below:

R_{f}(CH₂)ₛ—SO₂—N(R₅)—(CH₂)_{s′}—N⁺(R₆)(R₇)—(CH₂)ᵤ—COO⁻ (4.12)

R_{f}(CH₂)ₛ—SO₂—N(R₅)—(CH₂)_{s′}—N⁺(R₆)(R₇)—(CH₂)ᵥ—SO₃⁻ (4.13)

R_{f}(CH₂)_{w}—S—CH₂CH(OH)—CH₂—N⁺(R₆)(R₇)—(CH₂)ᵤ—COO⁻ (4.14)

R_{f}(CH₂)_{w}—S—CH₂CH(OH)—CH₂—N⁺(R₆)(R₇)—(CH₂)ᵥ—SO₃⁻ (4.15)

R_{f}(CH₂)_{w}—S—CH(COO⁻)—CH₂CONH(CH₂)_{s′}—N⁺H(R₆)(R₇) (4.16)

R_{f}(CH₂)ₛ—SO₂—N(R₈)—(CH₂)_{s′}—N(R₆)(R₇)→O (4.17)

R_{f}(CH₂)_{w}—S—CH₂—CH(OH)—CH₂—N⁺(R₆)(R₇)(R₉),Cl⁻ (4.18)

in which:
R_{f} represents a radical represented by formula (4′) or by formula (4″) as described above,
R₅ represents a hydrogen atom or a linear or branched alkyl radical including from 1 to 4 carbon atoms,
s′ and u, which may be identical or different, represent an integer greater than or equal to 1 and less than or equal to 5,
v represents an integer equal to 2 or 3,
R₆, R₇ and R₉, which may be identical or different, each represent a methyl or ethyl radical,
w represents an integer greater than or equal to 1 and less than or equal to 6;
   those of formulae (4.19), (4.20), (4.21), (4.22) and (4.23) below:

C_{r′}F_{2r′+1}—CH₂—CH₂—SO₂—NH—CH₂—CH₂—N⁺(CH₃)₂—COO′ (4.19),

C_{r′}F_{2r′+1}—CH₂—CH₂—S—CH₂—CH(OH)—CH₂—N⁺(CH₃)₂—CH₂—COO⁻ (4.20),

C_{r′}F_{2r′+1}—CH₂—CH₂—SO₂—N(CH₃)—(CH₂)₃—N⁺(CH₃)₂—CH₂—CH₂—CH₂—COO⁻ (4.21),

C_{r′}F_{2r′+1}—CH₂—CH₂—SO₂—NH—(CH₂)₃—N(CH₃)₂→O (4.22),

C_{r′}F_{2r′+1}—CH₂—CH₂—S—CH(COO⁻)CH₂CONH(CH₂)₃—N⁺H(CH₃)₂ (4.23),

in which r′ is an even integer greater than or equal to 4 and less than or equal to 20, and it is more particularly even and greater than or equal to 6 and less than or equal to 20;
those of formulae (4.24), (4.25), (4.26), (4.27), (4.28), (4.29), (4.30), (4.31) and (4.32) below:

C₆F₁₃—CH₂—CH₂—SO₂—NH—CH₂—CH₂—N⁺(CH₃)₂—COO⁻ (4.24)

C₆F₁₃—CH₂—CH₂—SO₂—NH—CH₂—CH₂—CH₂₋N⁺(CH₃)₂₋CH₂₋—COO⁻ (4.25)

C₈F₁₇—SO₂—NH—CH₂—CH₂—CH₂—N⁺(CH₃)₂—CH₂—COO⁻ (4.26)

C₆F₁₃—CH₂—CH₂—SO₂—NH—CH₂—CH₂—CH₂₋N⁺(CH₃)₂₋CH₂₋CH₂₋COO⁻ (4.27)

C₆F₁₃—CH₂—CH₂—SO₂—NH—CH₂—CH₂—CH₂₋N⁺(CH₃)₂₋CH₂₋CH₂₋CH₂₋COO⁻ (4.28)

C₆F₁₃—CH₂—CH₂—SO₂—N(CH₃)—CH₂—CH₂—CH₂₋N⁺(CH₃)₂₋CH₂₋CH₂₋CH₂₋COO⁻ (4.29)

C₆F₁₃—CH₂—CH₂—S—CH₂₋CH(OH)—CH₂—N⁺(CH₃)₂—CH₂—COO⁻ (4.30)

C₆F₁₃—CH₂—CH₂—SO₂—NH—(CH₂)₃—N(CH₃)₂→O (4.31)

C₆F₁₃—CH₂—CH₂—SO₂—N(CH₃)—(CH₂)₃—N(CH₃)₂→O (4.32)

In the context of the present invention, the term “thickener” denotes a chemical compound or a chemical composition which increases the viscosity of the medium into which it is introduced. In the context of the present invention, the term “gelling agent” denotes a chemical compound or a chemical composition which transforms a liquid medium into a structured state, which does not flow, by formation of a three-dimensional network within the liquid; the gel being considered as an intermediate state between the liquid state and the solid state.

In the context of the present invention, the term “polysaccharides” denotes saccharide polymers. The IUPAC definition of saccharides designates monosaccharides, compounds of monosaccharides per se and derivatives thereof, obtained either by reduction of a carbonyl group, or by oxidation of one or more hydroxyl functions, or by the replacement of one or more hydroxyl functions with a hydrogen atom, an amine group, a phosphate function, or a sulfate function. The polysaccharides most commonly used for preparing industrial food, cosmetic or pharmaceutical compositions predominantly consist of monosaccharides, such as glucose, galactose, mannose or of monosaccharide derivatives for which the hydroxyl function of the terminal carbon has been oxidized to a carboxyl function. Two distinct groups may be distinguished among the polysaccharides: polysaccharides consisting solely of monosaccharides (or poly-monosaccharides) and polysaccharides consisting of monosaccharide derivatives.

According to a particular aspect, the gelling agents and/or thickeners present in the aqueous composition (C_{E}) that is the subject of the present invention are chosen from polysaccharides consisting solely of monosaccharides (or poly-monosaccharides).

Among the polysaccharides composed solely of monosaccharides, a distinction may be made between glucans, which are homopolymers of glucose that are very abundant in nature, glucomannoglycans, xyloglycans and galactomannans, which are polymers whose main chain consists of D-mannose units, connected together at β-1,4, and on which D-galactose units are grafted laterally by α-1,6 bonds. Galactomannans are present in several plant species, and more particularly in the leguminous species in which they constitute the albumen of seeds. Depending on their plant origin, the degree of substitution (DS) of the D-galactose units on the D-mannose main chain of galactomannans ranges between 0 and 1:
galactomannans originating from cassia gum have a degree of substitution (DS) of approximately ⅕, meaning the lateral grafting of one D-galactose unit every 5 D-mannose units present on the main chain of the polysaccharide;
galactomannans originating from locust bean gum have a degree of substitution (DS) of approximately ¼, meaning the lateral grafting of one D-galactose unit every 4 D-mannose units present on the main chain of the polysaccharide;
galactomannans originating from tara gum have a degree of substitution (DS) of approximately ⅓, meaning the lateral grafting of one D-galactose unit every 3 D-mannose units present on the main chain of the polysaccharide;
galactomannans originating from guar gum have a degree of substitution (DS) of approximately ½, meaning the lateral grafting of one D-galactose unit every 2 D-mannose units present on the main chain of the polysaccharide;
galactomannans originating from fenugreek gum have a degree of substitution (DS) of approximately 1/1, meaning the lateral grafting of one D-galactose unit for virtually every D-mannose unit present on the main chain of the polysaccharide.

According to a more particular aspect, the gelling agents and/or thickeners present in the aqueous composition (C_{E}) that is the subject of the present invention are chosen from polysaccharides consisting solely of monosaccharides (or poly-monosaccharides) included in the group consisting of galactomannan originating from tara gum, galactomannan originating from guar gum and galactomannan originating from locust bean gum.

According to another particular aspect, the gelling agents and/or thickeners present in the aqueous composition (C_{E}) that is the subject of the present invention are chosen from polysaccharides consisting of monosaccharide derivatives. Among the polysaccharides consisting of monosaccharide derivatives, a distinction may be made between:
sulfated galactans, which are polymers of galactose which may have pendent sulfate-ester groups, represented notably by algal polysaccharides such as carrageenans and agar;
uronans, which are the polymers of uronic acids such as algins and pectins;
heteropolymers of monosaccharides and uronic acids: often of complex composition, these polymers are found notably in sap exudates (for instance gum arabic exudate and karaya gum exudate), but they are also produced by microorganisms, for instance xanthan gum and gellan gum;
glucosaminoglycans which are polysaccharides formed from a glucose derived by replacing its C-2 hydroxyl with an amine (referred to as 2-amino-2-deoxy-D-glucose or, more simply, glucosamine). The amine function may also be acetylated. Among the hydrocolloids in this class are chitosan, formed solely of glucosamine units, and hyaluronan, the repeating unit of which is a dimer of glucosamine and glucuronic acid.

Xanthan gum (G_{X}) has in recent decades become the microbial polysaccharide that is the most widely used in industry. Xanthan is a polysaccharide synthesized by bacteria of the genus Xanthomonas and, commercially, only the species X. campestris is used. The main chain of (G_{X}) is identical to that of cellulose, i.e. it is formed from β-D-glucose units connected together via carbons 1 and 4. There is one branched triholoside every two glucose units in the main chain, in a regular alternating manner; each branch consists of a triholoside composed of two mannoses and a glucuronic acid, of the type: β-D-Manp-(1→4)-β-D-GlcAp-(1→2)-α-D-Manp-(1→3) [I. Capron et al. “About the native and renaturated conformation of xanthan exopolysaccharide”. 1997). Xanthan gum (XG) is available in the form of a sodium, potassium or calcium salt.

Acacia gum is a complex, branched polysaccharide whose main chain consists of β-D-galactose units connected together via carbons 1 and 3. The chains branched to the main chain consist of β-D-galactose units connected together via carbons 1 and 6, also bearing α-arabinose units, and to a lesser extent β-glucoronosyl units. Both the main chain and the pendent chains contain α-L-arabinosyl, α-L-rhamnopyranosyl, β-D-glucuronopyranosyl and 4-O-methyl-β-D-glucuronopyranosyl units.

According to a more particular aspect, the gelling agents and/or thickeners present in the aqueous composition (C_{E}) that is the subject of the present invention are polysaccharides consisting of monosaccharide derivatives chosen from the elements of the group consisting of carrageenans, agar, algins, pectins, acacia gum exudate, karaya gum exudate, xanthan gum, gellan gum, chitosan and hyaluronan, and/or mixtures thereof.

According to another more particular aspect, the gelling agents and/or thickeners present in the aqueous composition (C_{E}) that is the subject of the present invention are polysaccharides consisting of monosaccharide derivatives chosen from the elements of the group consisting of gum arabic exudate, karaya gum exudate and xanthan gum, and/or mixtures thereof.

According to an even more particular aspect, the gelling agents and/or thickeners present in the aqueous composition (C_{E}) that is the subject of the present invention are polysaccharides consisting of monosaccharide derivatives chosen from the elements of the group consisting of acacia gum exudate, xanthan gum (G_{X}), the mixture of xanthan gum (G_{X}) and acacia gum exudate (G_{A}) used in a mass ratio between the xanthan gum (G_{X}) and the acacia gum exudate (G_{A}) of greater than or equal to ⅓ and less than or equal to 3/1, sold notably by the company SEPPIC under the brand name Solagum™ AX.

According to a particular aspect, the gelling agents and/or thickeners present in the aqueous composition (C_{E}) that is the subject of the present invention are chosen from cellulose and cellulose derivatives.

In the context of the present invention, the term “cellulose” denotes a polysaccharide consisting of a linear chain of D-glucose molecules, the average molecular mass of which is at least 10 000 g·mol⁻¹, more particularly at least 15 000 g·mol⁻¹, more particularly at least 17 000 g·mol⁻¹, even more particularly at least 20 000 g·mol⁻¹ and even more particularly at least 25 000 g·mol⁻¹.

In the context of the present invention, the term “cellulose derivatives” denotes the elements of the group consisting of hydroxyethylcellulose, methylcellulose, ethylcellulose, methylhydroxyethylcellulose, methylhydroxypropylcellulose, hydroxypropylcellulose, the sodium salt of carboxymethylcellulose, and cellulose dihydroxypropyl ether (as described in the American patent published under the number U.S. Pat. No. 4,096,326).

In the context of the present invention, the term “starch” denotes a mixture of amylose and amylopectin, and more particularly the elements of the group consisting of corn starch, wheat starch, potato starch and cassava starch.

According to a particular aspect, the term “linear or branched or crosslinked polymers of polyelectrolyte type” denotes, for the purposes of the present invention:
Crosslinked synthetic anionic copolymers based on methacrylic acid or acrylic acid, or esters of methacrylic acid or of acrylic acid, which are optionally hydrophically modified, prepared by direct emulsion polymerization. These synthetic anionic copolymers are known, respectively, to a person skilled in the art under the names “Alkaline Swellable Emulsion” (or “ASE”) and “Hydrophobically Alkaline Swellable Emulsion” (or “HASE”). Thickeners of HASE type are described in the international patent application published under the number WO 02/34793 A2;
Crosslinked or branched synthetic anionic polyelectrolytes, which are crosslinked and/or branched homopolymers or copolymers of water-soluble unsaturated monomers, such as acrylic acid and/or derivatives thereof, methacrylic acid and/or derivatives thereof, acrylamide and/or derivatives thereof, 2-acrylamido-2-methylpropanesulfonic acid and/or salts thereof, N-vinylpyrrolidone, vinyl alcohol and/or derivatives thereof. These crosslinked or branched synthetic anionic polyelectrolytes are in the form of reverse latices, obtained by reverse emulsion radical polymerization, or in the form of powders, obtained by precipitating polymerization, or by atomization of reverse latices.

According to a particular aspect, the gelling agents and/or thickeners present in the aqueous composition (C_{E}) that is the subject of the present invention are chosen from linear or branched or crosslinked polyelectrolytes, obtained from the radical polymerization of at least one monomer selected from the elements of the group consisting of acrylic acid and/or the sodium salt thereof, methacrylic acid and/or the sodium salt thereof, 2-hydroxyethyl acrylate, 2-hydroxyethyl methacrylate, acrylamide, N,N-dimethylacrylamide, N-isopropylacrylamide, 2-acrylamido-2-methylpropanesulfonic acid and/or the sodium or the potassium salt thereof, N-vinylpyrrolidone, in the presence of a crosslinking agent chosen from polyethylenic monomers comprising at least two ethylenic functions, and more particularly chosen from elements of the group consisting of ethylene glycol dimethacrylate, tetraallyloxyethane, ethylene glycol diacrylate, diallylurea, triallylamine, trimethylolpropane triacrylate or methylenebis(acrylamide), or a mixture of these compounds.

According to a particular aspect, the gelling agents and/or thickeners present in the aqueous composition (C_{E}) that is the subject of the present invention are chosen from the elements of the group consisting of:
partially or totally salified acrylic acid homopolymer, crosslinked with triallylamine and/or with trimethylolpropane triacrylate and/or with methylenebis(acrylamide),
the homopolymer of the sodium salt of 2-acrylamido-2-methylpropanesulfonic acid, crosslinked with triallylamine and/or with trimethylolpropane triacrylate and/or with methylenebis(acrylamide),
the copolymer of the sodium salt of 2-acrylamido-2-methylpropanesulfonic acid and of partially or totally salified acrylic acid, crosslinked with triallylamine and/or with trimethylolpropane triacrylate and/or with methylenebis(acrylamide),
the copolymer of the sodium salt of 2-acrylamido-2-methylpropanesulfonic acid and of 2-hydroxyethyl acrylate, crosslinked with triallylamine and/or with trimethylolpropane triacrylate and/or with methylenebis(acrylamide),
the copolymer of the sodium salt of 2-acrylamido-2-methylpropanesulfonic acid and of acrylamide, crosslinked with triallylamine and/or with trimethylolpropane triacrylate and/or with methylenebis(acrylamide),
the terpolymer of the sodium salt of 2-acrylamido-2-methylpropanesulfonic acid, of acrylamide and of partially or totally salified acrylic acid, crosslinked with triallylamine and/or with trimethylolpropane triacrylate and/or with methylenebis(acrylamide),
the terpolymer of the sodium salt of 2-acrylamido-2-methylpropanesulfonic acid, of N,N-dimethylacrylamide and of partially or totally salified acrylic acid, crosslinked with triallylamine and/or with trimethylolpropane triacrylate and/or with methylenebis(acrylamide).

According to a more particular aspect, the gelling agents and/or thickeners present in the aqueous composition (C_{E}) that is the subject of the present invention are chosen from the elements of the group consisting of xanthan gum (G_{X}), acacia gum exudate (G_{A}), the mixture of xanthan gum (G_{X}) and of acacia gum exudate (G_{A}) in a mass ratio between the xanthan gum (G_{X}) and the acacia gum exudate (G_{A}) which is greater than or equal to ⅓ and less than or equal to 3/1, the copolymer of the sodium salt of 2-acrylamido-2-methylpropanesulfonic acid and of 2-hydroxyethyl acrylate, crosslinked with triallylamine and/or with trimethylolpropane triacrylate and/or with methylenebis(acrylamide), the copolymer of the sodium salt of 2-acrylamido-2-methylpropanesulfonic acid and of acrylamide, crosslinked with triallylamine and/or with trimethylolpropane triacrylate and/or with methylenebis(acrylamide).

According to another particular aspect, a subject of the invention is the aqueous composition (C_{E}) as defined previously, characterized in that it comprises, per 100% of its mass:
a)—from 0.1% to 25% by mass, more particularly from 0.15% to 25% by mass and even more particularly from 0.2% to 25% by mass of said mixture (M₁) in which:
the compound of formula (I) is chosen from mono sodium N-cocoylglutamate, mono potassium N-cocoylglutamate, disodium N-cocoylglutamate and di-potassium N-cocoylglutamate,
the compound of formula (II) is chosen from sodium cocoate and potassium cocoate,
in formula (III), R₃ represents a linear or branched, saturated or unsaturated aliphatic radical including from 12 to 16 carbon atoms, G₃ represents a glucose or xylose residue and p represents a decimal number greater than or equal to 1.05 and less than or equal to 2.5;
in formula (IV), R₃ represents a linear or branched, saturated or unsaturated aliphatic radical including from 12 to 16 carbon atoms,
in formula (V), R₄ represents an aliphatic radical chosen from n-heptyl (n-C₇H₁₅—) and 2-ethylhexyl radicals, G₄ represents a glucose or xylose residue and q represents a decimal number greater than or equal to 1.05 and less than or equal to 2,
in formula (VI), R₄ represents an aliphatic radical chosen from n-heptyl (n-C₇H₁₅—) and 2-ethylhexyl radicals;
   b)—from 55% to 99.75%, more particularly from 58.5% to 99.7% by mass and even more particularly from 61% to 99.65% by mass of water,
   c)—from 0.05% to 10% by mass, more particularly from 0.05% to 7.5% by mass and even more particularly from 0.05% to 6% by mass of at least one fluoro surfactant (FSA) chosen from nonionic surfactants and amphoteric surfactants, and
   d)—from 0.1% to 10% by mass, more particularly from 0.1% to 9% by mass and even more particularly from 0.1% to 8% by mass of at least one gelling agent and/or thickener (GA) chosen from xanthan gum (G_{X}), acacia gum exudate (G_{A}), the mixture of xanthan gum (G_{X}) and of acacia gum exudate (G_{A}) in a mass ratio between the xanthan gum (G_{X}) and the acacia gum exudate (G_{A}) which is greater than or equal to ⅓ and less than or equal to 3/1.

The aqueous composition (C_{E}) that is the subject of the present invention may optionally comprise additional ingredients that are usually found in compositions intended for fire extinction, for example inorganic salts, salts of organic compounds, non-fluoro surfactants, urea and or urea derivatives, solvents, antioxidants, preserving agents or anticorrosion agents.

The term “inorganic salts” denotes heteropolar compounds whose crystal lattice comprises the participation of at least one type of cation other than the hydrogen ion and of at least one type of anion other than the hydroxide ion, for instance salts consisting of a cation which is the ammonium ion or a metal cation and of an anion selected from the elements of the group consisting of halides, carbonates, bicarbonates, phosphates, nitrates, borates and sulfates, and more particularly sodium, magnesium or calcium chloride; aluminum, barium, ammonium or zinc sulfate heptahydrate, potassium aluminum sulfate; aluminum, manganese or zinc borate; strontium or potassium tetraborate hydrate; sodium, aluminum, zinc, manganese or magnesium dihydrogen phosphate, monocalcium, monopotassium, zinc, manganese or aluminum phosphate, copper, iron, nickel, manganese, zinc, beryllium, cerium, calcium, lithium, cobalt, chromium, zirconium, strontium or potassium carbonate or sodium carbonate hexahydrate; calcium or strontium hydrogen phosphate; disodium, dimanganese or dizinc hydrogen phosphate; potassium, sodium, calcium or magnesium bicarbonate; iron, titanium, zinc or antimony oxide; iron ammonium sulfate, magnesium ammonium phosphate; magnesium hydrogen sulfate; strontium, barium or magnesium metaborate hydrate; magnesium trisilicate, sodium, zirconium or magnesium nitrate, potassium metaphosphate, potassium tripolyphosphate, sodium trimetaphosphate, ammonium molybdate, ammonium octamolybdate or ammonium heptamolybdate.

The term “salts of organic compounds” denotes a salt consisting of a cation which is the ammonium ion or a metal cation and of an organic anion which is an organic compound bearing at least one carboxylic acid function in carboxylate form or at least one sulfonic acid function in sulfonate form or at least one sulfate function, for example ammonium, sodium, copper, magnesium or potassium citrate; calcium, copper, sodium, potassium, strontium or zinc acetate; sodium, ammonium, aluminum, manganese or potassium oxalate.

Among the non-fluoro surfactants that are optionally present in composition (C_{E}), there are anionic non-fluoro surfactants, cationic non-fluoro surfactants or amphoteric non-fluoro surfactants. As examples of anionic non-fluoro surfactants, examples that may be mentioned include alkyl ether sulfates, alkyl sulfates, alkylamido ether sulfates, alkylaryl polyether sulfates, monoglyceride sulfates, α-olefin sulfonates, paraffin sulfonates, alkyl phosphates, alkyl ether phosphates, alkyl sulfonates, alkylamidesulfonates, alkylarylsulfonates, alkyl carboxylates, alkylsulfosuccinates, alkyl ether sulfosuccinates, alkylamide sulfosuccinates, alkylsulfoacetates or acyllactylates of alkali metals, of alkaline-earth metals, of ammonium, of amines or of amino alcohols.

As examples of amphoteric non-fluoro surfactants that are optionally present in composition (C_{E}) which is a subject of the present invention, examples that may be mentioned include alkylbetaines, alkylamidobetaines, sultaines, alkylamidoalkylsulfobetaines, imidazoline derivatives, phosphobetaines, amphopolyacetates and amphopropionates.

As examples of cationic non-fluoro surfactants that are optionally present in composition (C_{E}) which is a subject of the present invention, examples that may be mentioned include quaternary ammonium derivatives.

As examples of solvents that are optionally present in composition (C_{E}) which is a subject of the present invention, examples that may be mentioned include polyhydric alcohols such as glycerol, diglycerol, triglycerol, glycerol oligomers, xylitol, erythritol, sorbitol, 2-methyl-1,3-propanediol; alkoxylated polyhydric alcohols; glycols such as butylene glycol, hexylene glycol, caprylyl glycol or 1,2-octanediol or 1,2-pentanediol, pentylene glycol, monopropylene glycol, dipropylene glycol, isoprene glycol, butyl diglycol, trimethyl trimethylene glycol, polyethylene glycols with a molecular weight of 200 g·mol⁻¹ and 8000 g·mol⁻¹.

According to a particular aspect, per 100% by mass of composition (C_{E}), the solvents as described above may constitute a mass proportion of greater than or equal to 0.5% and less than or equal to 10%, more particularly greater than or equal to 0.5% and less than or equal to 5%, greater than or equal to 0.5% and less than or equal to 3%, greater than or equal to 0.8% and less than or equal to 3%.

As examples of preserving agents that are optionally present in composition (C_{E}) which is a subject of the present invention, examples that may be mentioned include benzoic acid, sodium benzoate, formaldehyde, dichloropene, ortho-phenylphenol, phenoxyethanol, methyl p-hydroxybenzoate, ethyl p-hydroxybenzoate, propyl p-hydroxybenzoate, isopropyl p-hydroxybenzoate, butyl p-hydroxybenzoate, benzyl alcohol, methylchloroisothiazolinone, methylisothiazolinone, and any chemical composition or any chemical compound that can prevent the proliferation of bacteria or of molds.

According to a particular aspect, per 100% by mass of composition (C_{E}), the preserving agents as described above may constitute a mass proportion, and may be used in a mass proportion, of greater than or equal to 0.01% and less than or equal to 3%, more particularly greater than or equal to 0.05% and less than or equal to 3%.

As examples of anticorrosion agents and/or antioxidants that are optionally present in composition (C_{E}) that is the subject of the present invention, examples that may be mentioned include urea, alkanolamines, sodium and/or potassium and/or calcium salts of organic acids, for instance sodium lactate, sodium citrate, sodium gluconate, sodium ascorbate, sodium succinate, and/or inorganic salts, for instance sodium nitrite, sodium molybdate, sodium phosphates and/or polyphosphates and/or any other compound known to those skilled in the art.

According to another aspect, a subject of the invention is the use of said surfactant mixture (M₁), or of said composition (C_{A}), or of said composition (C_{E}) as defined previously, for preparing a firefighting foam liquid;

A subject of the invention is also a process for extinguishing a fire, characterized in that it comprises:
at least one step A₁ of preparing a foam obtained by mixing a composition (C_{E}) as defined in either of claims 13 and 14 with a gas or a mixture of gases, chosen from air, nitrogen or carbon dioxide, followed by
at least one step A₂ of placing the foam prepared in step A₁ in contact with the surface that is on fire.
The foam prepared in step A₁ of the process that is the subject of the present invention is generated by any foam-generating system known to those skilled in the art and described in the prior art, for instance mechanical stirring of the aqueous composition (C_{E}), bubbling of one or more gases into the aqueous composition (C_{E}), the use of a static ball mixer or any other device for ensuring mixing between the gas or the mixture of gases and the aqueous composition (C_{E}), or else a device using a projection or spray nozzle.
The foam prepared in step A₁ of the process that is the subject of the present invention may be produced by various items of equipment known to those skilled in the art, for instance injectors, lances, generators or spouts.

According to a particular aspect, a subject of the invention is the process as defined above, characterized in that step A₁ consists of a step A₁′ of diluting said composition (C_{E}) with water, in a (C_{E})/water volume ratio of between 10/90 and 1/99, followed by a step A₁″ of mixing the dilute composition obtained on conclusion of step A₁′ with a gas or a mixture of gases chosen from air, nitrogen or carbon dioxide.

Step A₁′ of dilution of the aqueous composition (C_{E}) with water may be performed via any means known to those skilled in the art, for instance in tanks of suitable dimensions and with stirring at a suitable rate. More particularly, the water of dilution and the aqueous composition (C_{E}) may be transported separately, and then conveyed to a generator which creates the foam by mixing the water of dilution and composition (C_{E}) with air, and then sprays it, at variable and adjustable flow rates, towards the fire surface to be treated. In such a case, the mixing of water of dilution and of the aqueous composition (C_{E}) with air is performed by air suction during the expansion of the dilute foam solution.

In the process of the invention, step A₂ of placing in contact the foam created during step A₁) or step A₁″ is performed by spraying onto the surface that is on fire to be treated, via means known to those skilled in the art, for instance a lance, a generator, a firefighting cannon.

### DESCRIPTION OF THE PREFERRED EMBODIMENTS

The examples that follow illustrate the invention without, however, limiting it.

### 1) Preparation of Foaming Compositions

1.1) Preparation of a Solution of Disodium N-Cocoyl Glutamate [Composition (C₁)].

315 kg of water and 177.2 kg of monosodium sodium glutamate monohydrate are placed in a reactor, with stirring and at a temperature of 20° C., followed by 152.5 kg of an aqueous sodium hydroxide solution at 30% by mass so as to reach a pH of 12. 167 kg of cocoyl chloride, which is a mixture of acid chlorides comprising, per 100% by mass, 8% by mass of octanoyl chloride, 8% by mass of decanoyl chloride, 50% by mass of lauroyl chloride, 17% by mass of myristoyl chloride, 8% by mass of palmitoyl chloride, 3% by mass of stearoyl chloride, 4% by mass of oleoyl chloride and 2% by mass of linoleoyl chloride, are then added gradually with stirring, followed by a further 110 kg of the 30% sodium hydroxide solution to keep the pH between 11 and 12. The temperature is maintained between 20° C. and 50° C. for 2 hours.

The mixture obtained is acidified by adding 65 kg of an aqueous sulfuric acid solution at 70% by mass, and is then diluted with 75 kg of water to obtain an aqueous solution of disodium N-cocoyl glutamate [composition (C₁)].

1.2) Analytical Features Composition

The analytical features of composition (C₁) are collated in table 1 below.

TABLE 1

| | (C₁) |
|---|---|
| Appearance at 20° C. (visual method) | Clear |
| Mass content of water (a) (according to the standard | 56.1% |
| NFT 73-201) | |
| Residual fatty acids (b) (gas chromatography (GC)) | 8.2% |
| pH | 6.3 |
| Sodium chloride content (potentiometric titration (c) | 4.6% |
| Sodium sulfate content (d) (calculated on feedstock) | 5.6% |
| Mass content of active material (AM₁) (cocoyl glutamate) | 25.5% |
| (AM₁) = 100% − (a) − (b) − (c) − (d) | |

### 2) Preparation of the Alkylpolyglycoside-Based Surfactant Compositions

### 2.1) Preparation of a Composition (C₃)

3.7 molar equivalents of a mixture of fatty alcohols (N₁) consisting, per 100% of its mass, of 68% by mass of 1-dodecanol, of 25% by mass of 1-tetradecanol and of 7% by mass of 1-hexadecanol, and then 1 molar equivalent of anhydrous glucose are poured with stirring into a reactor maintained at 80° C., followed by 0.15% by mass of 98% sulfuric acid per 100% by mass of the mixture.

The reaction medium is placed under a partial vacuum of about 0.18×10⁵ Pa (180 mbar) and maintained at 100° C.-105° C. for 4 hours with distillation of the water formed.

After cooling to 85° C.-90° C. and neutralizing by addition of 40% sodium hydroxide, the reaction medium thus obtained is discharged at 70° C. and filtered to remove the grains of unreacted glucose.

The filtrate is then poured into another reactor and the excess of the mixture of fatty alcohols (N₁) is removed by distillation using a thin-film evaporator, and the residue is then diluted in water. After stirring for 30 minutes at 50° C., composition (C₃) is obtained, which comprises 50% by mass of water and 50% by mass of a mixture of alkylpolyglucosides (AM_{APG1}), for which the proportions of alkylpolyglucosides and the mean degree of polymerization of their polyglucoside residue are determined by gas chromatography (GC); it thus comprises, per 100% by mass, 69% by mass of n-dodecyl polyglucosides, 25% by mass of n-tetradecyl polyglucosides and 6% by mass of n-hexyldecyl polyglucosides with a degree of polymerization equal to 1.25.

2.2) Preparation of a Composition (C₄) Comprising n-Heptyl Polyglucoside

2.7 molar equivalents of 1-heptanol and then 1 molar equivalent of anhydrous glucose are poured with stirring into a reactor maintained at 40° C., followed by 0.15% by mass of 98% sulfuric acid per 100% by mass of the mixture.

The reaction medium is placed under a partial vacuum of about 0.18×10⁵ Pa (180 mbar) and maintained at 100° C.-105° C. for 4 hours with distillation of the water formed.

After cooling to 85° C.-90° C. and neutralizing by addition of 40% sodium hydroxide, the reaction medium thus obtained is discharged at 70° C. and filtered to remove the grains of unreacted glucose.

The filtrate is then poured into another reactor and the excess heptanol is distilled off under partial vacuum, and the residue is then diluted in water.

After stirring for 30 minutes at 50° C., composition (C₄) is obtained comprising 26.4% by mass of water and 73.6% by mass of n-heptyl polyglucosides (AM_{APG2}), with a degree of polymerization, determined by GC, equal to 1.25.

### 3) Preparation of Compositions According to the Invention and of Comparative Compositions

Four compositions, (T₁)_{inv.}, (T₂)_{inv.}, (T₃)_{inv.} and (T₄)_{inv.} according to the invention and comparative two compositions (T₅)_{comp.} and (T₆)_{comp.} are prepared by pouring, with stirring, into a reactor maintained at 40° C., the composition (C₁) and at least one of the compositions (C₃) or (C₄). The mixture is stirred for 30 minutes to obtain one of the compositions (T₁)_{inv.} to (T₄)_{inv.} and (T₅)_{comp.} and (T₆)_{comp.}. The amounts used are collated in table 2 below:

TABLE 2

| | Amounts used | | | | |
|---|---|---|---|---|---|
| | (C₁) | (C₃) | (C₄) | | (C₁) |
| (T₁)_{inv.} | 74.9 g | 11.1 g | 14.0 g | (T₁)_{inv.} | 74.9 g |
| (T₂)_{inv.} | 73.8 g | 15.6 g | 10.6 g | (T₂)_{inv.} | 73.8 g |
| (T₃)_{inv.} | 72.8 g | 19.9 g | 7.3 g | (T₃)_{inv.} | 72.8 g |
| (T₄)_{inv.} | 75.7 g | 8.0 g | 16.4 g | (T₄)_{inv.} | 75.7 g |
| (T₅)_{comp.} | 72.1 g | 22.7 g | 5.2 g | (T₅)_{comp.} | 72.1 g |
| (T₆)_{comp.} | 76.0 g | 0 g | 24.0 g | (T₆)_{comp.} | 76.0 g |

The analytical features of comparative compositions (T₁)_{inv.}, (T₂)_{inv.}, (T₃)_{inv.}, (T₄)_{inv.}, (T₅)_{comp.} and (T₆)_{comp.} are collated in table 3 below.

TABLE 3

| | FA⁽¹⁾ | T⁽²⁾ | T′⁽³⁾ | H₂O (%) | Δ ₁⁽⁴⁾ | Appearance |
|---|---|---|---|---|---|---|
| (T₁)_{inv.} | 5.84% | 61.4% | 38.6% | 52.32% | 35/65 | Homogeneous |
| (T₂)_{inv.} | 5.76% | 61.8% | 38.2% | 53.04% | 50/50 | Homogeneous |
| (T₃)_{inv.} | 5.68% | 62.2% | 38.8% | 53.74% | 65/35 | Homogeneous |
| (T₄)_{inv.} | 5.90% | 61.1% | 38.9% | 51.85% | 25/75 | Homogeneous |
| (T₅)_{comp.} | 5.62% | 62.4% | 37.6% | 54.18% | 74.8/25.2 | Homogeneous |
| (T₆)_{comp.} | 5.93% | 58.8% | 41.2% | 50.03% | 0/100 | Homogeneous |

⁽¹⁾Residual fatty acids (mass percentage)
⁽²⁾T = (AM₁)/[(AM₁) + (AM_{APG1}) + (AM_{APG2})]
⁽³⁾T′ = [(AM_{APG1}) + (AM_{APG2})]/[(AM₁) + (AM_{APG1}) + (AM_{APG2})]
⁽⁴⁾Δ ₁ = (AM_{APG1})/(AM_{APG2})

### 4) Evaluation of the Foaming Properties

4.1) Principle of the Evaluation Method

The evaluation of the foaming properties of the test compositions is performed by forming a foam, from a solution of OMS hard water comprising a predetermined mass content of the test compositions, by mechanical stirring at a temperature of 20° C.

4.2) Experimental Protocol

250 cm³ aqueous solutions are prepared so as to obtain solutions containing 0.5% by mass of surfactant active material in OMS hard water, from the compositions (T₁)_{inv.}, (T₂)_{inv.}, (T₃)_{inv.}, (T₄)_{inv.}. (T₅)_{comp.}, (T₆)_{comp.}, (C₁), (C₃) and (C₄).

250 cm³ aqueous solutions containing 0.39% of surfactant active material in OMS hard water from the compositions (C₁), and also a 250 cm³ aqueous solution containing 0.11% of surfactant active material in OMS hard water from the composition (C₁) are also prepared.

The OMS hard water contains, per liter of permuted water, 0.403 g of anhydrous calcium chloride and 0.139 g of magnesium chloride hexahydrate; which gives it a hardness titer equal to 34°Th.

These solutions are poured into a 500 cm³ beaker and are then stirred using a Rayneri™ laboratory blender (model 33/300) equipped with a butterfly paddle with three hollow arms, at a constant speed of 3000 rpm for 2 minutes.

4.3) Expressing the Results

The following parameters are measured for each test:
The expansion time (T_{exp.}): this is the stirring time after which suppression of the vortex in the beaker is observed. Beyond this time, the foam totally surrounds the shaft of the paddle and its level is horizontal;
The half-life time (T_{1/2}): this is the time after which the foam obtained from a certain volume of foaming solution became drained of an amount of solution corresponding to half of the initial volume. For this test, the half-life time is reached when the upper level of the draining water reaches the 125 cm³ mark on the beaker;
The height of foam generated by stirring (Hₜₒ): this is the height of foam generated at the end of the 2 minutes of stirring;
The residual foam height after 30 minutes (Hₜ₃₀): this is the foam height observed 30 minutes after the end of the 2 minutes of stirring.
The difference Δ_{H}=(Hₜₒ−Hₜ₃₀), makes it possible to evaluate comparatively the quality of the foams generated by the various surfactants.
The degree of expansion (T_{F}): this is the value of the ratio between the volume of foam (Vₘ) produced by a foaming composition to the volume (Vₛ) of the foaming solution used (water and foam liquid).

4.4) Results Obtained

The results obtained for the aqueous solutions of active material in the OMS hard water for compositions (T₁)_{inv.}, (T₂)_{inv.}, (T₃)_{inv.}, (T₄)_{inv.}, (T₅)_{comp.}, (T₆)_{comp.}, (C₁), (C₃) and (C₄) are indicated in table 4 below.

| 0.50% | (Tₑₓₚ) | | (T_{1/2}) | (Hₜₒ) | (Hₜ₃₀) | (ΔH) | (T_{F}) |
|---|---|---|---|---|---|---|---|
| (T₁)_{inv.} | 12 | s | 48 min | 160 mm | 145 mm | 15 mm | 6.5 |
| (T₂)_{inv.} | 13 | s | 40 min | 170 mm | 145 mm | 25 mm | 6.6 |
| (T₃)_{inv.} | 24 | s | 36 min | 170 mm | 145 mm | 25 mm | 6.5 |
| (T₄)_{inv.} | 10 | s | 46 min | 170 mm | 145 mm | 25 mm | 6.7 |
| (T₅)_{comp.} | 22 | s | 12 min | 175 mm | n.m. | n.m. | n.m. |
| (T₆)_{comp.} | 44 | s | 30 min | 125 mm | 115 mm | 10 mm | 6.8 |
| (C₁) | 27 | s | 37 min | 145 mm | 120 mm | 25 mm | 6.4 |
| (C₃) | >2 | min | n.m. | n.m. | n.m. | n.d. | n.m. |
| (C₄) | >2 | min | n.m. | n.m. | n.m. | n.d. | n.m. |

n.m. : not measurable;
n.d. : not determined

4.5) Analysis of the Results

These results show that the compositions according to the invention make it possible to prepare foams having all the qualities required for use in firefighting, unlike the comparative compositions.

### 5) Formulation Examples

The proportions of constituents are expressed as mass percentages.

### 5.1) Firefighting Foam Liquid Composition of ARAFFF Type

Formula

| | |
|---|---|
| Monopropylene glycol: | 10% |
| Rhodopol ™ 23 ⁽¹⁾ | 1% |
| Sipol ™ C₁₂-C₁₄⁽²⁾ | 1% |
| Composition (T₁)_{inv.} | 10% |
| Forafac ™ 1157 ⁽³⁾ | 2% |
| Forafac ™ 1157 N ⁽⁴⁾ | 2% |
| Urea | 10% |
| Seawater | qs 100% |

⁽¹⁾ Rhodopol ™ 23 Xanthan gum sold by the company Rhodia,
⁽²⁾ Sipol ™ C₁₂-C₁₄, mixture of fatty alcohols comprising, by weight, 85% of C₁₂ alcohol and 15% of C₁₄ alcohol, sold by the company BASF,
⁽³⁾ and ⁽⁴⁾: amphoteric fluoro surfactants manufactured by the company Arkema, of general formula: CₙF_{2n + 1}—CH₂—CH₂—SO₂—NH—CH₂—CH₂—CH₂—N⁺(CH₃)₂—CH₂—COO^{—}

### 5.2) Firefighting Foam Liquid Composition of ARAFFF Type

Formula

| | |
|---|---|
| Monopropylene glycol: | 10% |
| Solagum ™ AX⁽⁵⁾ | 1.2% |
| Sipol ™ C₁₂-C₁₄⁽²⁾ | 1% |
| Composition (T₁)_{inv.} | 10% |
| Forafac ™ 1157 ⁽³⁾ | 2% |
| Forafac ™ 1157 N ⁽⁴⁾ | 2% |
| Urea | 10% |
| Seawater | qs 100% |

⁽⁵⁾: Solagum ™ AX (INCI name: Acacia Senegal gum & xanthan gum) is an emulsifying agent sold by the company SEPPIC.

1- A surfactant mixture (M₁) comprising, per 100% of its mass:
(i)—from 50% to 99% by mass of a composition (C₁) comprising, per 100% of its mass:
(α)—from 65 mass % to 90 mass % of at least one compound of formula (I):
R₁—C(═O)—NH—CH(COOH)—(CH₂)₂—COOH (I)
in partially or totally salified acid form in which the group R₁—C(═O)— represents a linear or branched, saturated or unsaturated acyl radical including from 8 to 18 carbon atoms, and
(β)—from 10% by mass to 35% by mass of at least one compound of formula (II):
R₁—C(═O)—OH (II)
in partially or totally salified acid form in which the group R₁ is as defined for formula (I),
(ii)—from 1% to 50% by mass of a composition (C₂) comprising, per 100% of its mass:
(γ)—from 14% to 80% by mass of a composition (C₃) or of a mixture of compositions (C₃), said composition (C₃) being represented by formula (III):
R₃—O-(G₃)ₚ-H (III)
in which R₃ represents a linear or branched, saturated or unsaturated aliphatic radical including from 12 to 16 carbon atoms, G₃ represents a reducing sugar residue and p represents a decimal number greater than or equal to 1.05 and less than or equal to 5, said composition (C₃) consisting of a mixture of compounds represented by formulae (III₁), (III₂), (III₃), (III₄) and (III₅):
R₃—O-(G₃)₁-H (III₁),
R₃—O-(G₃)₂-H (III₂),
R₃—O-(G₃)₃-H (III₃),
R₃—O-(G₃)₄-H (III₄),
R₃—O-(G₃)₅-H (III₅),
in the respective molar proportions a₁, a₂, a₃, a₄ and a₅, such that:
the sum a₁+a₂+a₃+a₄+a₅ is equal to 1, and
the sum a₁+2a₂+3a₃+4a₄+5 as is equal to p;
(δ)—from 0% to 3% by mass of at least one alcohol of formula (IV):
R₃—OH (IV)
in which R₃ is as defined for the preceding formula (III),
(ϵ)—from 20% to 80% of a composition (C₄) or of a mixture of compositions (C₄), said composition (C₄) being represented by formula (V):
R₄—O-(G₄)_{q}-H (V)
in which R₄ represents a linear aliphatic radical, chosen from butyl, pentyl (nC₅H₁₁—), hexyl (nC₆H₁₃—) and heptyl (nC₇H₁₅—) radicals, G₄ represents a reducing sugar residue and q represents a decimal number greater than or equal to 1.05 and less than or equal to 5, said composition (C₄) consisting of a mixture of compounds represented by formulae (V₁), (V₂), (V₃), (V₄) and (V₅):
R₄—O-(G₄)₁-H (V₁),
R₄—O-(G₄)₂-H (V₂),
R₄—O-(G₄)₃-H (V₃),
R₄—O-(G₄)₄-H (V₄),
R₄—O-(G₄)₅-H (V₅),
in the respective molar proportions a′₁, a′₂, a′₃, a′₄ and a′₅, such that:
the sum a′₁+a′₂+a′₃+a′₄+a′₅ is equal to 1, and
the sum a′₁+2a′₂+3a′₃+4a′₄+5a′₅ is equal to q; and
(η)—from 0% to 3% by mass of at least one alcohol of formula (VI):
R₄—OH (VI)
in which R₄ is as defined for the preceding formula (V).

2- The surfactant mixture M₁ as defined in claim 1, wherein, in formulae (I) and (II), the group R₁—C(═O)— represents an acyl radical chosen from octanoyl, decanoyl, dodecanoyl, tetradecanoyl, hexadecanoyl, octadecanoyl, 9-octadecenoyl, 9,12-octadecadienoyl and 9,12,15-octadecatrienoyl radicals.

3- The surfactant mixture (M₁) as defined in claim 1, wherein said composition (C₂) comprises, per 100% of its mass:
(γ)—a mass proportion of said composition (C₃) of greater than or equal to 14% and less than 70%, and
(δ)—a mass proportion of said alcohol of formula (IV) of greater than or equal to 0% and less than or equal to 3%,
(ε)—a mass proportion of said composition (C₄) of greater than or equal to 30% and less than or equal to 80%, and
(η)—a mass proportion of said alcohol of formula (VI) of greater than or equal to 0% and less than or equal to 3%.

4- The surfactant mixture (M₁) as defined in claim 1, wherein, in formula (III), G₃ represents a reducing sugar residue chosen from glucose, xylose and arabinose residues.

5- The surfactant mixture (M₁) as defined in claim 1, wherein, in formula (III), p represents a decimal number greater than or equal to 1.05 and less than or equal to 2.5.

6- The surfactant mixture (M₁) as defined in claim 1, wherein, in formulae (III) and (IV), R₃ represents a linear alkyl radical chosen from dodecyl, tetradecyl and hexyldecyl radicals.

7- The surfactant mixture (M₁) as defined in claim 1, wherein, in formula (V), G₄ represents a reducing sugar residue chosen from glucose, xylose and arabinose residues.

8- The surfactant mixture (M₁) as defined in claim 1, wherein, in formula (V), q represents a decimal number greater than or equal to 1.05 and less than or equal to 2.5.

9- The surfactant mixture (M₁) as defined in claim 1, wherein, in formulae (V) and (VI), R₄ represents a linear alkyl radical chosen from hexyl and heptyl radicals.

10- The surfactant mixture (M₁) as defined in claim 1, wherein said composition (C₂) comprises a mixture of compositions (C₃) and of compositions (C₄), said mixture comprising, per 100% of its mass:
(γ₁)—from 13.6% to 44.4% by mass of a composition (C₃) represented by formula (III) in which R₃ represents the dodecyl radical,
(γ₂)—from 5% to 16.25% by mass of a composition (C₃) represented by formula (III) in which R₃ represents the tetradecyl radical, and
(γ₃)—from 1.4% to 4.55% by mass of a composition (C₃) represented by formula (III) in which R₃ represents the hexadecyl radical,
(ϵ₁)—from 35% to 80% by mass of a composition (C₄) represented by formula (V) in which R₄ represents the heptyl radical (nC₇H₁₅).

11- The surfactant mixture (M₁) as defined in claim 1, wherein the mass ratio:
Δ=Mass of compound (s) of formula (I)/[Mass of composition (C₃)+Mass of composition (C₄)], is greater than or equal to 20/80 and less than or equal to 65/35.

12- The surfactant mixture (M₁) as defined in claim 1, wherein the mass ratio:
Δ₁=Mass of composition (C₃)/Mass of composition (C₄) is greater than or equal to 20/80 and less than or equal to 70/30.

13- A composition (C_{A}) comprising, per 100% by mass:
a)—from 5% to 85% by mass of said (M₁) as defined in claim 1, and
b)—from 15% to 95% by mass of water.

14- A composition (C_{E}) comprising, per 100% by mass:
a)—from 0.1% to 25% by mass of said mixture (M₁) as defined in claim 1,
b)—from 55% to 99.75% by mass of water,
c)—from 0.05% to 10% by mass of at least one fluoro surfactant (FSA) chosen from anionic, cationic, nonionic and amphoteric fluoro surfactants.
d)—from 0.1% to 10% by mass of at least one gelling agent and/or thickener (GA) chosen from polysaccharides consisting of monosaccharide derivatives, polysaccharides consisting solely of monosaccharides, cellulose and cellulose derivatives, starches and linear or branched or crosslinked polyelectrolytes.

15- The composition (C_{E}) as defined in claim 14, further comprising, per 100% of its mass:
a)—from 0.1% to 25% by mass of said mixture (M₁) in which:
the compound of formula (I) is chosen from monosodium N-cocoyl glutamate, monopotassium N-cocoyl glutamate, disodium N-cocoyl glutamate and dipotassium N-cocoyl glutamate,
the compound of formula (II) is chosen from sodium cocoate and potassium cocoate,
in formula (III), R₃ represents a linear or branched, saturated or unsaturated aliphatic radical including from 12 to 16 carbon atoms, G₃ represents a glucose or xylose residue and p represents a decimal number greater than or equal to 1.05 and less than or equal to 2.5;
in formula (IV), R₃ represents a linear or branched, saturated or unsaturated aliphatic radical including from 12 to 16 carbon atoms,
in formula (V), R₄ represents the n-heptyl (nC₇H₁₅) radical, G₄ represents a glucose or xylose residue and q represents a decimal number greater than or equal to 1.05 and less than or equal to 2,
in formula (VI), R₄ represents the n-heptyl (nC₇H₁₅) and 2-ethylhexyl radical,
b)—from 55% to 99.75% by mass of water,
c)—from 0.05% to 10% by mass of at least one fluoro surfactant (FSA) chosen from nonionic and amphoteric fluoro surfactants.
d)—from 0.1% to 10% by mass of at least one gelling agent and/or thickener (GA) chosen from xanthan gum (G_{X}), acacia gum exudate (G_{A}), the mixture of xanthan gum (G_{X}) and of acacia gum exudate (G_{A}) in a mass ratio between the xanthan gum (G_{X}) and the acacia gum exudate (G_{A}) which is greater than or equal to ⅓ and less than or equal to 3/1.

16- A firefighting foam liquid comprising the surfactant mixture (M₁) as defined in claim 1.

17- A process for extinguishing a fire, comprising:
at least one step A₁ of preparing a foam obtained by mixing a composition (C_{E}) as defined in claim 14 with a gas or a mixture of gases, chosen from air, nitrogen or carbon dioxide, followed by
at least one step A₂ of placing the foam prepared in step A₁ in contact with the surface that is on fire.

18- The process as claimed in claim 17, wherein step A₁ consists of a step A₁′ of diluting said composition (C_{E}) with water, in a (C_{E})/water volume ratio of between 10/90 and 1/99, followed by a step step A₁″ of mixing the dilute composition obtained on conclusion of step A₁′ with a gas or a mixture of gases chosen from air, nitrogen or carbon dioxide.

19. The surfactant mixture (M₁) as defined in claim 2, wherein said composition (C₂) comprises, per 100% of its mass:
(γ)—a mass proportion of said composition (C₃) of greater than or equal to 14% and less than 70%, and
(δ)—a mass proportion of said alcohol of formula (IV) of greater than or equal to 0% and less than or equal to 3%,
(ε)—a mass proportion of said composition (C₄) of greater than or equal to 30% and less than or equal to 80%, and
(η)—a mass proportion of said alcohol of formula (VI) of greater than or equal to 0% and less than or equal to 3%.

20. The surfactant mixture (M₁) as defined in claim 2, wherein, in formula (III), G₃ represents a reducing sugar residue chosen from glucose, xylose and arabinose residues.
